(19) United States
(12) Patent Application Publication
(10) Pub. No.: US 2013/0241964 A1
(43) Pub. Date: Sep. 19, 2013

(54) DISPLAY DEVICE AND ELECTRONIC APPARATUS

(71) Applicant: JAPAN DISPLAY WEST, INC., Aichi-Ken (JP)

(72) Inventors: Tsuyoshi Ohyama, Tokyo (JP); Takeo Koito, Kanagawa (JP)

(73) Assignee: JAPAN DISPLAY WEST, INC., Aichi-Ken (JP)

(21) Appl. No.: 13/772,463

(22) Filed: Feb. 21, 2013

(30) Foreign Application Priority Data
Mar. 13, 2012 (JP) 2012-055755

(51) Int. Cl. G09G 3/20

(52) U.S. Cl. CPC G09G 3/2003
USPC 345/690

(57) ABSTRACT

A display device includes: a display portion in which pixel openings displaying colors included in a pixel are arranged in a first direction and a second direction which is different from the first direction, and the ratio of colors displayed by the pixel openings arranged in the same line is equal to the ratio of colors included in the pixel; and a light separation portion dividing an image displayed on the display portion into plural viewpoint images by spatially separating light, and the dividing direction is switched between the first direction and the second direction.

### FIELD

The present disclosure relates to a display device and an electronic apparatus.

### BACKGROUND

A technique in which light is spatially separated by using a parallax barrier, a lenticular lens and the like, and an image displayed on a display portion is divided into plural viewpoint images to be presented to an observer is known. The technique is used for, for example, a 3D display device presenting images with a parallax given to the right and left eyes of the observer, a directional display device displaying different images in accordance with the observation direction and other devices.

The image displayed on the display portion is displayed as an aggregate of pixels. A pixel includes a given number of sub-pixels. Each sub-pixel displays one color respectively, and the color of the pixel is expressed by mixing these colors. Here, respective sub-pixels correspond to pixel openings arranged in the display portion. The pixel openings prescribe display areas of respective colors by allowing light of respective colors to be transmitted therethrough or allowing electric fields for making self-luminous devices emit light to pass through.

When an arrangement cycle of the pixel openings does not match with a cycle of images displayed on the display portion being allocated to respective viewpoint images, color deviation may occur in the viewpoint images to be observed. Accordingly, for example, JP-A-2009-3256 (Patent Document 1) discloses a technique in which the number of sub-pixels located in odd-numbered positions in the arrangement is equal to the number of sub-pixels located in even-numbered positions, thereby preventing the color deviation in the viewpoint images.

### SUMMARY

However, though the color deviation in the entire viewpoint images can be solved, pixels of the same color are aligned in a vertical direction of the viewpoint image as shown, for example, in FIG. 3 of Patent Document 1. Accordingly, the color deviation is distributed in vertical stripes in the viewpoint image, which may be observed as color moire.

There is also proposed, as a new technique, a technique in which an image is divided in different directions to generate viewpoint images, for example, as in a case of displaying 3D images by switching a vertical (portrait) screen and a horizontal (landscape) screen in a mobile device. Also in such case, it is necessary to suppress the color deviation in viewpoint images in respective directions.

In view of the above, it is desirable to provide a novel and improved display device and an electronic apparatus capable of suppressing the color deviation in respective viewpoint images when generating viewpoint images by dividing an image in different directions.

An embodiment of the present disclosure is directed to a display device including a display portion in which pixel openings displaying colors included in a pixel are arranged in a first direction and a second direction which is different from the first direction, and the ratio of colors displayed by the pixel openings arranged in the same line is equal to the ratio of colors included in the pixel, and a light separation portion dividing an image displayed on the display portion into plural viewpoint images by spatially separating light, and the dividing direction is switched between the first direction and the second direction.

Another embodiment of the present disclosure is directed to an electronic apparatus including a display device in which pixel openings displaying colors included in a pixel are arranged in a first direction and a second direction which is different from the first direction, and the ratio of colors displayed by the pixel openings arranged in the same line is equal to the ratio of colors included in the pixel, and a light separation portion dividing an image displayed on the display portion into plural viewpoint images by spatially separating light, and the dividing direction is switched between the first direction and the second direction.

When the ratio of colors arranged in the same line is equivalent in lines of the pixel openings in each direction, it is possible to prevent generation of a line in which any particular color is displayed in a deviated manner in viewpoint images in the case where the image is divided into viewpoint images. Therefore, it is possible to prevent deviation of colors as the entire viewpoint images as well as to prevent occurrence of an area with the color deviation in viewpoint images.

As explained above, according to the embodiments of the present disclosure, when the image is divided in plural directions to generate viewpoint images, color deviation can be suppressed in respective viewpoint images.

### BRIEF DESCRIPTION OF THE DRAWINGS

FIG. 1 is a view showing a schematic structure of a display device according to a first embodiment of the present disclosure;

FIG. 2 is a view showing a structure of color filters in the display device according to the first embodiment of the present disclosure;

FIG. 3 is a view showing an example in which a 3D image is displayed in a horizontal screen by using the display device according to the first embodiment of the present disclosure;

FIG. 4 is a view showing an example in which a 3D image is displayed in a vertical screen by using the display device according to the first embodiment of the present disclosure;

FIG. 5 is a view showing a schematic structure of a display device according to a second embodiment of the present disclosure;

FIG. 6 is a view showing an example in which a 3D image is displayed in a horizontal screen by using the display device according to the second embodiment of the present disclosure;

FIG. 7 is a view showing an example in which a 3D image is displayed in a vertical screen by using the display device according to the second embodiment of the present disclosure;

FIG. 8 is a view showing a comparative example of the second embodiment of the present disclosure;

FIG. 9 is a view showing a schematic structure of a display device according to a third embodiment of the present disclosure;

FIG. 10 is a view showing an example in which a 3D image is displayed in a horizontal screen by using the display device according to the third embodiment of the present disclosure;

FIG. 11 is a view showing an example in which a 3D image is displayed in a vertical screen by using the display device according to the third embodiment of the present disclosure;

FIG. 12 is a view showing another example of color arrangement of pixel openings according to the embodiment of the present disclosure;

FIG. 13 is a view showing another example of color arrangement of pixel openings according to the embodiment of the present disclosure; and

FIG. 14 is a schematic block diagram showing a configuration of an electronic apparatus according to an embodiment of the present disclosure.

### DETAILED DESCRIPTION

Hereinafter, the preferred embodiments of the present disclosure will be explained with reference to the attached drawings. In the present specification and the drawings, the same symbols are given to the components having substantially the same functions and structures to thereby omit repeated explanation.

The explanation will be made in the following order.

1. First Embodiment
1-1. Structure of Display Device
1-2. Structure of Color Filters
1-3. Example of Displaying Viewpoint Images

2. Second Embodiment
2-1. Structure of Display Device
2-2. Example of Displaying Viewpoint Images

3. Third Embodiment
3-1. Structure of Display Device
3-2. Example of Displaying Viewpoint Images

4. Other Embodiments

5. Supplement

### 1. First Embodiment

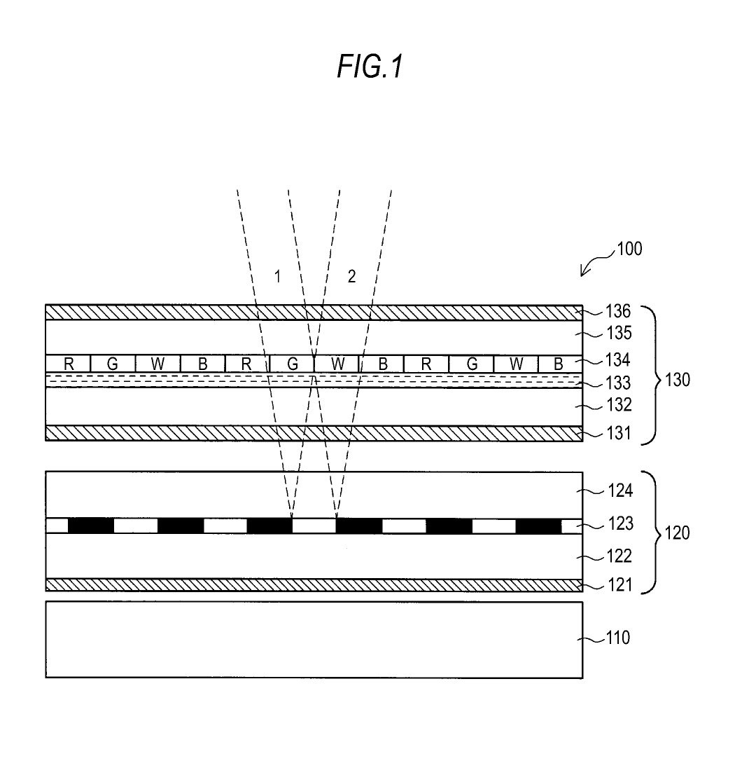

First, a first embodiment of the present disclosure will be explained with reference to FIG. 1 to FIG. 4.

### (1-1. Structure of Display Device)

FIG. 1 is a view showing a schematic structure of a display device according to the first embodiment of the present disclosure. Referring to FIG. 1, a display device 100 includes a backlight 110, a parallax barrier 120 and a liquid crystal display (LCD) 130. As shown in the drawing, the display device 100 is a rear-barrier 3D display device in which the parallax barrier 120 is arranged on the back side of the LCD 130.

In the following description, the embodiment relating to the 3D display device presenting viewpoint images having parallax to the right and left eyes of an observer will be explained. However, the structure of the 3D display device can be easily applied to, for example, a directional display device presenting different viewpoint images to plural observers at different positions respectively. That is, an embodiment relating to the directional display device can be also realized in the same manner as the embodiment relating to the 3D display device explained below.

The backlight 110 is a light source portion irradiating light to the LCD 130 through the parallax barrier 120. In the backlight 110, for example, a cold cathode fluorescent lamp (CCFL), a light emitting diode (LED) or the like is used as a light emitting device.

The parallax barrier 120 includes a polarizing plate 121, a terminal substrate 122, a liquid crystal layer 123 and a counter substrate 124. In the present embodiment, the parallax barrier 120 is a passive-matrix type liquid crystal display device. Transparent electrodes arranged on the terminal substrate 122 apply voltages to the liquid crystal 123 existing between the terminal substrate 122 and the counter electrode 124 on which transparent electrodes are arranged. As a result, transmissive portions allowing light to be transmitted therethrough and light-shielding portions blocking light are generated in the liquid crystal layer 123, and the parallax barrier 120 functions as a light separation portion which spatially separates light presented to the observer through the LCD 130.

In the present embodiment, as the parallax barrier 120 spatially separates light, an image displayed on the LCD 130 is divided into two viewpoint images for displaying a stereoscopic image (3D image). As described later, the parallax barrier 120 can switch the direction in which the image is divided between two directions of a vertical direction and a horizontal direction. Additionally, it is also possible to display normal 2D images on the display device 100 when the parallax barrier 120 does not generate the light-shielding portions in the liquid crystal layer 123 and does not spatially separate light.

The LCD 130 includes polarizing plates 131 and 136, a terminal substrate 132, a liquid crystal layer 133, color filters 134 and a counter substrate 135. In the present embodiment, the LCD 130 is an active-matrix liquid crystal display device. TFTs (thin-film transistors) and transparent pixel electrodes are arranged on the terminal substrate 132, applying voltages to the liquid crystal layer 133 existing between the terminal substrate 132 and the color filters 134 on which a transparent common electrode is formed. The LCD 130 controls light transmission from the backlight 110 in units of respective areas corresponding to respective colors arranged in the color filters 134 and controls light emission of respective colors included in the pixel to thereby display color images.

Here, pixel openings are arranged in the vertical and horizontal directions on the color filters 134. As the pixel openings allow light of respective colors included in the pixel to be transmitted therethrough, respective colors included in the pixel are displayed. A structure of the color filters 134 will be further explained below.

### (1-2. Structure of Color Filters)

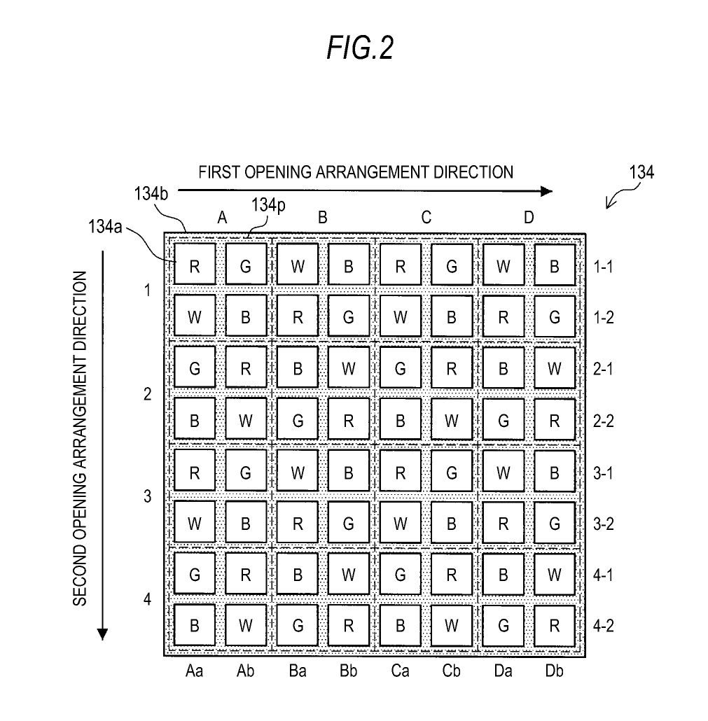

FIG. 2 is a view showing a structure of color filters in the display device according to the first embodiment of the present disclosure. Referring to FIG. 2, in the color filters 134, plural pixel openings 134a are formed by a black matrix 134b in the color filters 134. The pixel openings 134a are arranged in the horizontal direction (first opening arrangement direction) and the vertical direction (second opening arrangement direction). That is, the pixel openings 134a are arranged in a grid shape in the present embodiment. FIG. 2 is shown by simplifying part of the color filters 134 for explanation, and much more pixel openings 134a can be arranged in the actual color filters 134.

Respective pixel openings 134a are areas in which respective colors included in the pixel are displayed by allowing light of respective colors included in the pixel to be transmitted therethrough, which correspond to respective sub-pixels forming the pixels. In the LCD 130, the pixel includes four sub-pixels of R (red), G (green), B (blue) and W (white). Therefore, the ratio of colors included in the pixel is R:G:B:W=1:1:1:1.

In the drawing, pixels used when the display device 100 displays the normal 2D images are shown as pixels 134p. The shape of the pixels can be suitably modified, for example, in the case of 3D display, however, the ratio of colors included in the pixel is the same as the pixel 134p. In the following description, symbols of A to D may be used as lines in the vertical direction and symbols of 1 to 4 may be used as lines in the horizontal direction for designating positions of the pixels 134p. For example, the pixel 134p positioned at the upper left corner can be referred to as a “pixel 134p of A-1”. Moreover, symbols of Aa to Db may be used in the vertical direction as well as symbols of 1-1 to 4-2 may be used in the horizontal direction for designating one line of the pixel openings 134a.

### (Arrangement of Pixel Opening)

In the color filters 134, the ratio of colors to be displayed by the pixel openings 134a arranged in the same line in the horizontal direction and the vertical direction is equal to the ratio of colors included in the pixel. As an example, colors to be displayed by the pixel openings 134a arranged in a line Aa in the vertical direction are R, W, G, B, R, W, G and B from the top, and the ratio of colors is R:G:B:W=1:1:1:1. Similarly, colors to be displayed by the pixel openings 134a arranged in a line 1-1 in the horizontal direction are R, G, W, B, R, G, W and B from the left, and the ratio of colors is also R:G:B:W=1:1:1:1. As described above, as the ratio of colors included in the pixel is R:G:B:W=1:1:1:1, the ratio of colors to be displayed by the pixel openings 134a arranged in the same line in the horizontal direction and the vertical direction respectively is equal to the ratio of colors included in the pixel.

The color arrangement of the above-explained pixel openings 134a will be further explained in the light of the color arrangement of sub-pixels forming the pixel 134p. When the color arrangements of sub-pixels included pixels 134p A-1, A-2, B-1 and B-2 adjacent to one another are respectively written in the order of a Z-character from the upper left to the lower right, A-1 includes (R, G, W and B), A-2 includes (G, R, B and W), B-1 includes (W, B, R and G) and B-2 includes (B, W, G and R). In the color filters 134, the color arrangement of sub-pixels differs in respective pixels 134p adjacent to one another as described above.

As a result, in a block including the pixel openings 134a in the vertical and horizontal four lines, which is formed by the above four pixels 134p, a set of four colors of R, G, B and W of the pixel openings 134a is aligned in each of lines in the horizontal direction and in the vertical direction. In other words, the color arrangement to be displayed by the pixel openings 134a is repeated as a pattern including a set of four colors R, G, B and W in the vertical direction and in the horizontal direction. As the color arrangement is repeated as the pattern as described above, the ratio of colors to be displayed by the pixel openings 134a arranged in the same line can be easily made equal to the ratio of colors included in the pixel even when many pixel openings 134a are arranged.

Advantages due to the color arrangement of the pixel openings 134a will be explained in more detail while citing an example at the time of displaying viewpoint images.

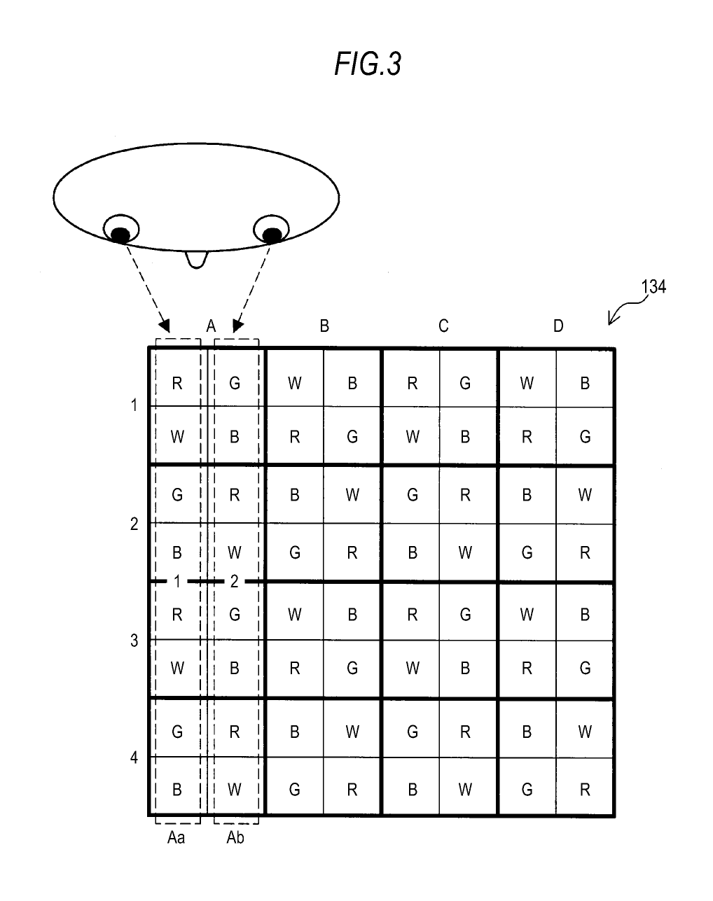

In the following description, the black matrix 134b and the like may be omitted concerning the color filters 134 as shown in FIG. 3 for explaining the relation between colors and viewpoint images. There also may be a case where an observer is shown in the drawing for schematically showing viewpoint images to be presented to the observer, however, shown positions of the observer do not necessarily correspond to actual positions of the observer.

### (1-3. Example of Displaying Viewpoint Images)

FIG. 3 is a view showing an example in which a 3D image is displayed in a horizontal screen by using the display device according to the first embodiment of the present disclosure. In this case, the parallax barrier 120 divides the image displayed on the LCD 130 in the vertical direction by generating the transmissive portions and the light-shielding portions in vertical stripes. A width of the transmissive portions in the parallax barrier 120 is set so as to correspond to one line of the pixel openings 134a in the vertical direction. Therefore, the pixel openings 134a are allocated line by line in the vertical direction as a first viewpoint image (right-eye image) and a second viewpoint image (left-eye image) alternately. In the shown example, a line Aa of the leftmost line is allocated as the first viewpoint image and a next line Ab is allocated as the second viewpoint image, which continue in this manner.

Here, as explained concerning the structure of the color filters 134, the ratio of colors to be displayed by the pixel openings 134a arranged in the same line in the vertical direction is equal to the ratio of colors included in the pixel. Accordingly, the ratio of colors in each line of the vertical direction will be the same as the ratio of colors of original pixels in each of the first and second viewpoint images in the shown example. Therefore, a line in which any particular color is displayed in a deviated manner is not generated in respective viewpoint images to be observed, which suppresses occurrence of color moire.

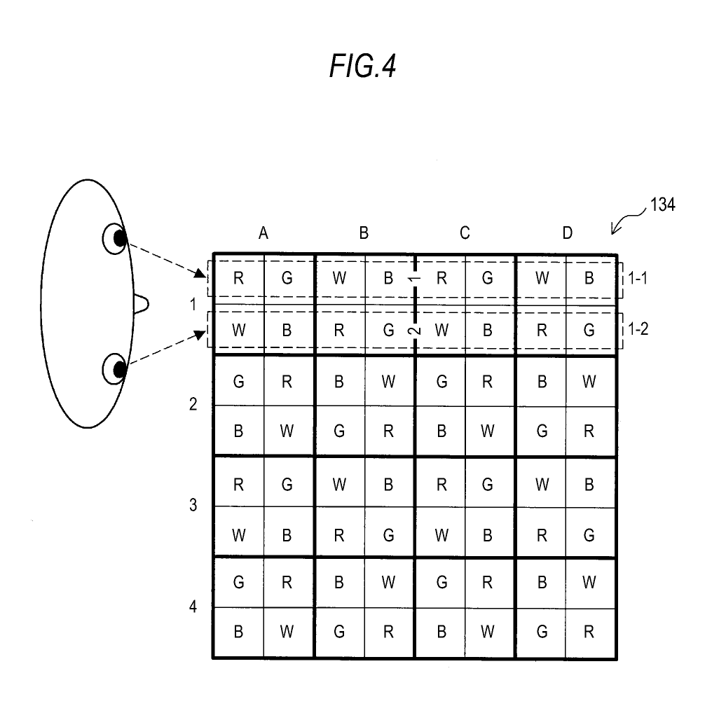

FIG. 4 is a view showing an example in which a 3D image is displayed in a vertical screen by using the display device according to the first embodiment of the present disclosure. In this case, the parallax barrier 120 divides the image displayed on the LCD 130 in the horizontal direction by generating the transmissive portions and the light-shielding portions in horizontal stripes. A width of the transmissive portions in the parallax barrier 120 is set so as to correspond to one line of the pixel openings 134a in the horizontal direction. Therefore, the pixel openings 134a are allocated line by line in the horizontal direction as a first viewpoint image (left-eye image) and a second viewpoint image (right-eye image) alternately. In the shown example, a line 1-1 on the top is allocated as the first viewpoint image and a next line 1-2 is allocated as the second viewpoint image, which continue in this manner.

Here, as explained concerning the structure of the color filters 134, the ratio of colors to be displayed by the pixel openings 134a arranged in the same line in the horizontal direction is equal to the ratio of colors included in the pixel. Accordingly, the ratio of colors in each line of the horizontal direction will be the same as the ratio of colors of original pixels in each of the first and second viewpoint images in the shown example. Therefore, a line in which any particular color is displayed in a deviated manner is not generated in respective viewpoint images to be observed, which suppresses occurrence of color moire.

The first embodiment of the present disclosure has been explained. In the present embodiment, the display device 100 is the rear-barrier 3D display device in which the parallax barrier 120 is disposed on the back side of the LCD 130, however, the embodiment of the present disclosure is not limited to the specific structure of the light separation portion. For example, the display device according to the embodiment of the present disclosure may be a front-barrier 3D display device in which the parallax barrier is disposed on the front side of the LCD. Additionally, the light separation portion is not limited to the parallax barrier but a liquid crystal lens to be explained in a subsequent second embodiment or a liquid lens can be used.

### 2. Second Embodiment

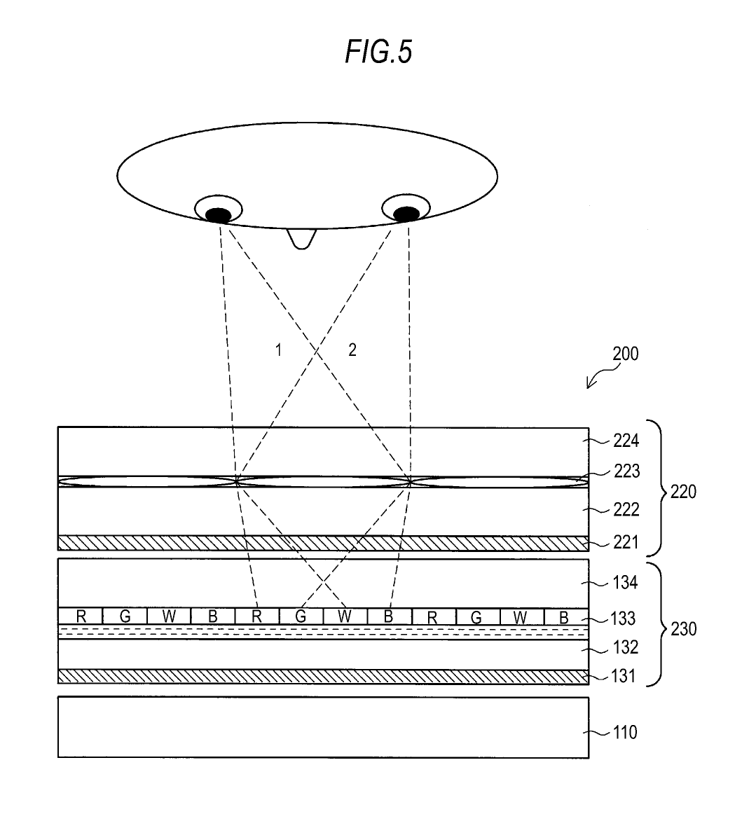

Subsequently, the second embodiment of the present disclosure will be explained with reference to FIG. 5 to FIG. 8.

### (2-1. Structure of Display Device)

FIG. 5 is a view showing a schematic structure of a display device according to the second embodiment of the present disclosure. Referring to FIG. 5, a display device 200 includes the backlight 110, an LCD 230 and a liquid crystal lens 220. The structure of the backlight 110 is the same as the one explained in the first embodiment. A structure of the LCD 230 is the same as the LCD 130 explained in the first embodiment including the color arrangement of the pixel openings 134a in the color filters 134 except that the positional relationship with respect to the liquid crystal lens 220 as the light separation portion is different (the light separation portion is arranged on the front side of the LCD 230). Therefore, repeated detailed explanation of these components is omitted.

The liquid crystal lens 220 includes a polarizing plate 221, a terminal substrate 222, a liquid crystal layer 223 and a counter substrate 224. Transparent electrodes arranged on the terminal substrate 222 apply voltages to the liquid crystal layer 223 existing between the terminal substrate 222 and the counter electrode 224 on which transparent electrodes are arranged, which changes a refractive index of light in the liquid crystal layer 223 in units of areas. Accordingly, a lens effect which is equivalently the same as a lenticular lens occurs in the liquid crystal layer 223, and the liquid crystal lens 220 functions as the light separation portion which spatially separates light presented to the observer through the LCD 230.

In the present embodiment, as the liquid crystal lens 220 spatially separates light, an image displayed on the LCD 230 is divided into two viewpoint images for displaying a 3D image. As described later, the liquid crystal lens 220 can switch the direction in which the image is divided between two directions of the vertical direction and the horizontal direction. Additionally, it is also possible to display normal 2D images on the display device 200 when the liquid crystal lens 220 allows the refractive index of light in the liquid crystal layer 223 to be uniform and does not spatially separate light to be presented to the observer through the LCD 230.

### (2-2. Example of Displaying Viewpoint Images)

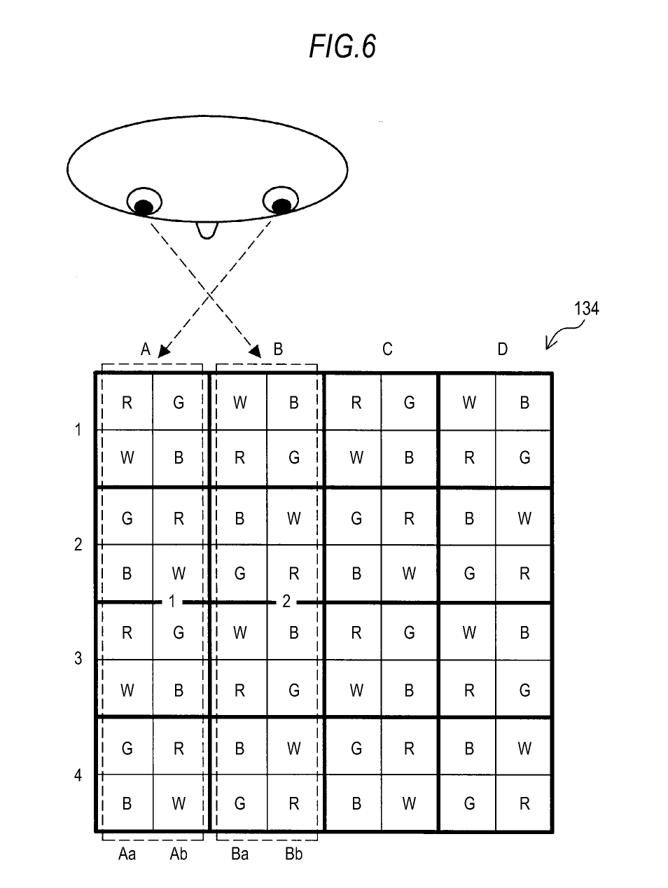

FIG. 6 is a view showing an example in which a 3D image is displayed in a horizontal screen by using the display device according to the second embodiment of the present disclosure. In this case, the liquid crystal lens 220 divides the image displayed on the LCD 230 in the vertical direction by generating the lens effect which is equivalently the same as the lenticular lens in which a cylindrical lens in the vertical direction is arranged. A focal length of the liquid crystal lens 220 is set so that a focusing width corresponds to two lines of the pixel openings 134a in the vertical direction. Therefore, the pixel openings 134a are allocated as a first viewpoint image (left-eye image) and a second viewpoint image (right-eye image) in units of two lines in the vertical direction. In the shown example, leftmost two lines Aa and Ab are allocated as the first viewpoint image and next two lines Bb and Bb are allocated as the second viewpoint image, which continue in this manner.

Here, as explained concerning the structure of the color filters 134, the ratio of colors to be displayed by the pixel openings 134a arranged in the same line in the vertical direction is equal to the ratio of colors included in the pixel. Accordingly, the ratio of colors in each line of the vertical direction will be the same as the ratio of colors of original pixels in each of the first and second viewpoint images in the shown example. Therefore, a line in which any particular color is displayed in a deviated manner is not generated in respective viewpoint images to be observed, which suppresses occurrence of color moire.

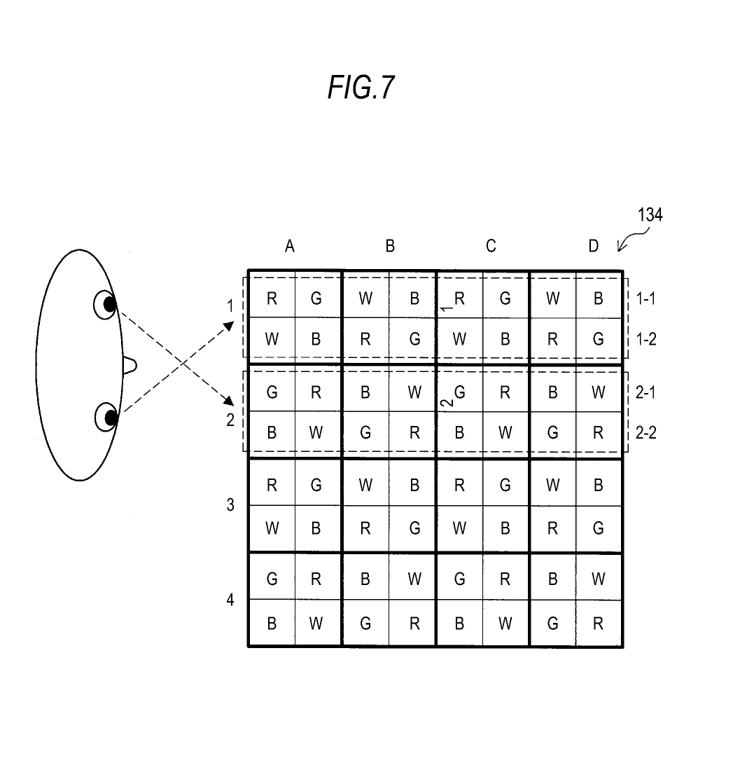

FIG. 7 is a view showing an example in which a 3D image is displayed in a vertical screen by using the display device according to the second embodiment of the present disclosure. In this case, the liquid crystal lens 220 divides the image displayed on the LCD 230 in the horizontal direction by generating the lens effect which is equivalently the same as the lenticular lens in which a cylindrical lens in the horizontal direction is arranged. The focal length of the liquid crystal lens 220 is set so that the focusing width corresponds to two lines of the pixel openings 134a in the horizontal direction. Therefore, the pixel openings 134a are allocated as a first viewpoint image (right-eye image) and a second viewpoint image (left-eye image) in units of two lines in the horizontal direction. In the shown example, top two lines 1-1 and 1-2 are allocated as the first viewpoint image and next two lines 2-1 and 2-2 are allocated as the second viewpoint image, which continue in this manner.

Here, as explained concerning the structure of the color filters 134, the ratio of colors to be displayed by the pixel openings 134a arranged in the same line in the horizontal direction is equal to the ratio of colors included in the pixel. Accordingly, the ratio of colors in each line of the horizontal direction will be the same as the ratio of colors of original pixels in each of the first and second viewpoint images in the shown example. Therefore, a line in which any particular color is displayed in a deviated manner is not generated in respective viewpoint images to be observed, which suppresses occurrence of color moire.

However, in the case where the number of colors included in the pixel is four, and the pixel openings are allocated as viewpoint images in units of two lines, it can be considered that color deviation does not occur in the image to be observed as long as the ratio of colors is the same in units of two lines even when the ratio of colors is not the same in respective lines, such as in a subsequent comparative example.

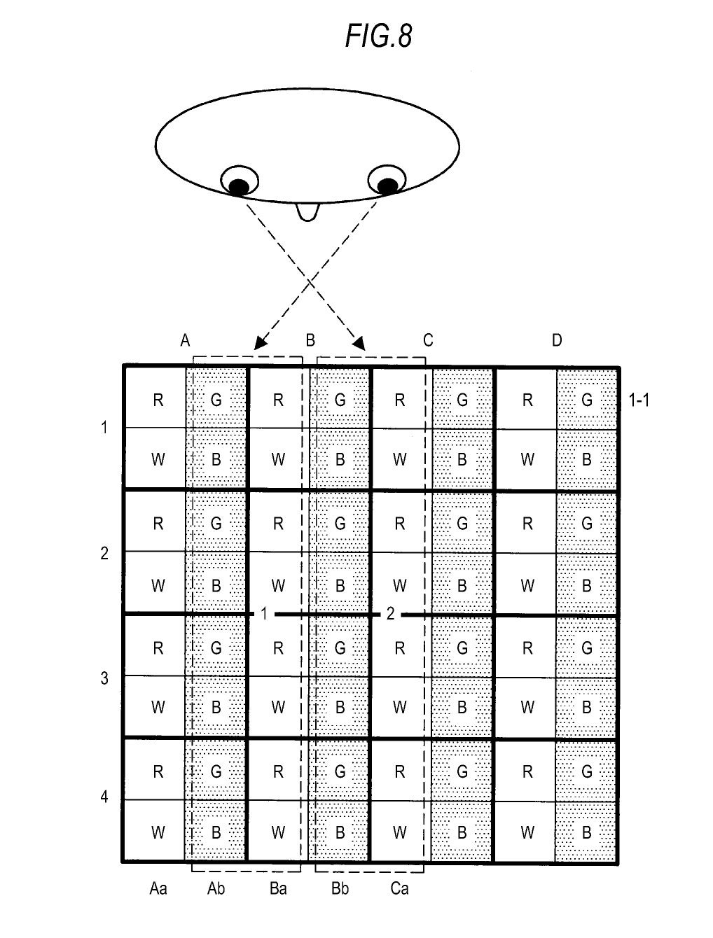

FIG. 8 is a view showing a comparative example of the second embodiment of the present disclosure. In the comparative example, the arrangement of sub-pixels included in the pixel is all the same (R, G, W and B in the order of a Z-character from the upper left to the lower right). Therefore, the ratio of colors displayed by the pixel openings arranged in the same line is not equal to the ratio of colors included in the pixel both in the horizontal direction and the vertical direction. For example, as only colors of R and W are arranged in the line Aa, the ratio of colors will be R:G:B:W=1:0:0:1. Additionally, as only colors of R and G are arranged in the line 1-1, the ratio of colors will be R:G:B:W=1:1:0:0. Both ratios are different from the ratio of colors included in the pixel, which is R:G:B:W=1:1:1:1.

On the other hand, the ratio of colors displayed by the pixel openings arranged in adjacent two lines is equal to the ratio of colors included in the pixel. For example, when two lines of the line Ab (only colors of G and B are arranged) and the line Ba (only colors of R and W are arranged) are added, the ratio of colors will be R:G:B:W=1:1:1:1, which is equal to the ratio of colors included in the pixel.

In the case, when the division into the viewpoint images by the liquid crystal lens and the like accurately corresponds to two lines of the pixel openings, the color deviation does not occur in the viewpoint images. For example, when the lines Ab and Ba are divided as the first viewpoint image and the lines Bb can Ca are divided as the second viewpoint image accuracy respectively, the ratio of colors obtained by adding the two lines as described above is equal to the ratio of colors included in the pixel, therefore, the color deviation does not occur in the viewpoint images.

However, the division into the viewpoint images may be deviated from the range of given lines due to positional deviation of the observer. For example, when the observer is moved to the right side, the line Ab (only colors of G and B are arranged) is positioned in the vicinity of the center in the range allocated as the first viewpoint image. Conversely, when the observer is moved to the left side, the line Ba (only colors of R and W are arranged) is positioned in the vicinity of the center of the range. As the line Ab and the line Ba are more visible than other lines in such state, the line in which a specific color is displayed in the deviated manner is generated in the viewpoint images, which may cause to be observed as color moire.

As described above, the embodiment of the present disclosure in which the ratio of colors in respective lines is equal to the ratio of colors included in the pixel is effective for suppressing occurrence color moire even when the pixel openings are allocated as the viewpoint images in units of two lines (or in units of three or more lines).

The structure in which the pixel openings are allocated as the viewpoint images in units of two lines as in the embodiment can be also realized, for example, by allowing the width of the transmissive portions of the parallax barrier explained in the first embodiment to correspond to two lines of the pixel openings.

### 3. Third Embodiment

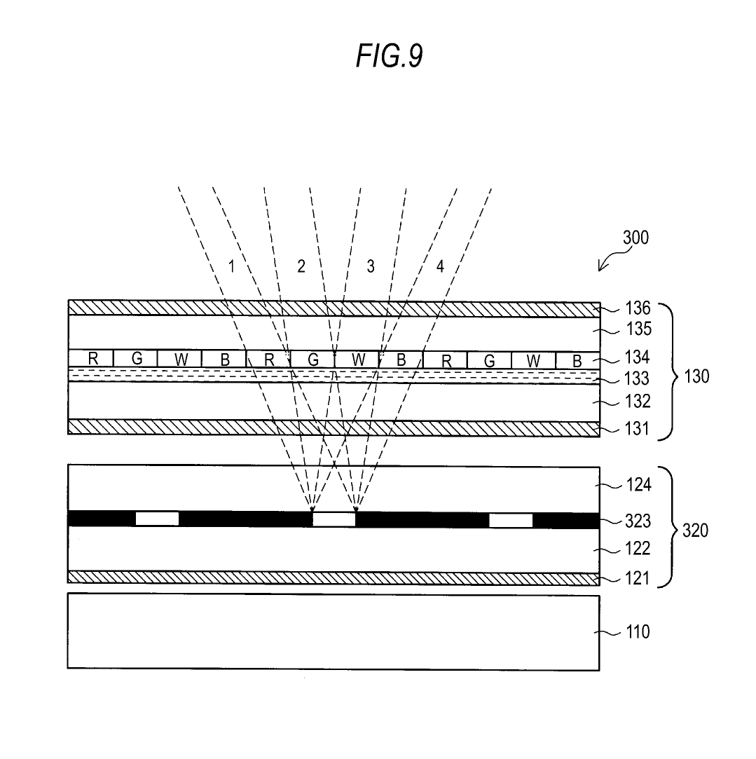

Subsequently, a third embodiment of the present disclosure will be explained with reference to FIG. 9 to FIG. 11.

### (3-1. Structure of Display Device)

FIG. 9 is a view showing a schematic structure of a display device according to the third embodiment of the present disclosure. Referring to FIG. 9, a display device 300 includes the backlight 110, a parallax barrier 320 and the liquid crystal display (LCD) 130. The structures of the backlight 110 and the LCD 130 are the same as the ones explained in the first embodiment including the color arrangement of the pixel openings 134a in the color filters 134. Therefore, repeated detailed explanation of these components is omitted.

The parallax barrier 320 includes the polarizing plate 121, the terminal substrate 122, a liquid crystal layer 323 and the counter substrate 124. In the present embodiment, the parallax barrier 320 is the passive-matrix type liquid crystal display device. Transparent electrodes arranged on the terminal substrate 122 apply voltages to the liquid crystal 323 existing between the terminal substrate 122 and the counter electrode 124 on which transparent electrodes are arranged. As a result, the transmissive portions allowing light to be transmitted therethrough and the light-shielding portions blocking light are generated in the liquid crystal layer 323, and the parallax barrier 320 functions as the light separation portion which spatially separates light presented to the observer through the LCD 130.

In the present embodiment, as the parallax barrier 320 spatially separates light, an image displayed on the LCD 130 is divided into four viewpoint images for displaying a 3D image. That is, the display device 300 is a 3D display device capable of displaying multi-viewpoint (four viewpoints) images. As described later, the parallax barrier 320 can switch the direction in which the image is divided between two directions of the vertical direction and the horizontal directions. Additionally, it is also possible to display normal 2D images on the display device 300 when the parallax barrier 320 does not generate the light-shielding portions in the liquid crystal layer 323 and does not separate light spatially.

### (3-2. Example of Displaying Viewpoint Images)

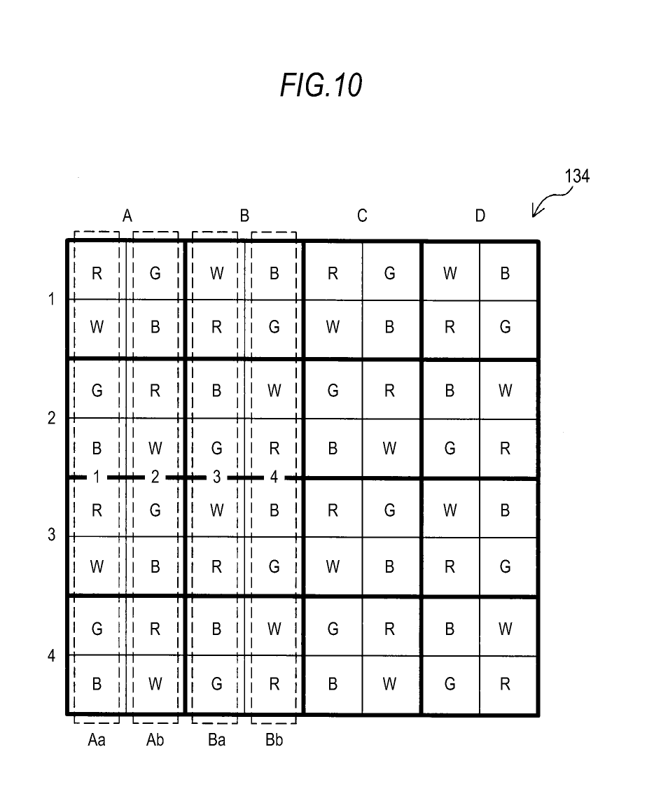

FIG. 10 is a view showing an example in which a 3D image is displayed in a horizontal screen by using the display device according to the third embodiment of the present disclosure. In this case, the parallax barrier 320 divides the image displayed on the LCD 130 in the vertical direction by generating the transmissive portions and the light-shielding portions in vertical stripes. A width of the transmissive portions in the parallax barrier 320 is set so as to correspond to one line of pixel openings 134a in the vertical direction. Therefore, the pixel openings 134a are sequentially allocated line by line in the vertical direction as a first viewpoint image, a second viewpoint image, a third viewpoint image and a fourth viewpoint image. In the shown example, the leftmost line Aa is allocated as the first viewpoint image, the second line Ab is allocated as the second viewpoint image, the third line Ba is allocated as the third viewpoint image and the fourth line Bb is allocated as the fourth viewpoint image, which continue in this manner.

Here, as explained concerning the structure of the color filters 134, the ratio of colors to be displayed by the pixel openings 134a arranged in the same line in the vertical direction is equal to the ratio of colors included in the pixel. Accordingly, the ratio of colors in each line of the vertical direction will be the same as the ratio of colors of original pixels in each of the first to fourth viewpoint images in the shown example. Therefore, a line in which any particular color is displayed in a deviated manner is not generated in respective viewpoint images to be observed, which suppresses occurrence of color moire.

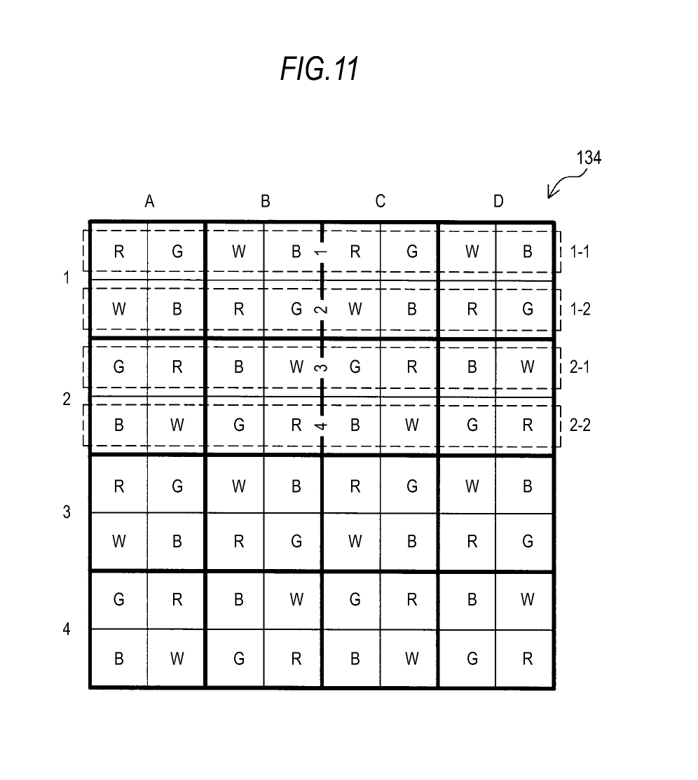

FIG. 11 is a view showing an example in which a 3D image is displayed in a vertical screen by using the display device according to the third embodiment of the present disclosure. In this case, the parallax barrier 320 divides the image displayed on the LCD 130 in the horizontal direction by generating the transmissive portions and the light-shielding portions in horizontal stripes. A width of the transmissive portions in the parallax barrier 320 is set so as to correspond to one line of pixel openings 134a in the horizontal direction. Therefore, the pixel openings 134a are sequentially allocated line by line in the horizontal direction as a first viewpoint image, a second viewpoint image, a third viewpoint image and a fourth viewpoint image. In the shown example, the line 1-1 on the top is allocated as the first viewpoint image, the second line 1-2 is allocated as the second viewpoint image, the third line 2-1 is allocated as the third viewpoint image and the fourth line 2-2 is allocated as the fourth viewpoint image, which continue in this manner.

Here, as explained concerning the structure of the color filters 134, the ratio of colors to be displayed by the pixel openings 134a arranged in the same line in the horizontal direction is equal to the ratio of colors included in the pixel. Accordingly, the ratio of colors in each line of the horizontal direction will be the same as the ratio of colors of original pixels in each of the first to fourth viewpoint images in the shown example. Therefore, a line in which any particular color is displayed in a deviated manner is not generated in respective viewpoint images to be observed, which suppresses occurrence of color moire.

The third embodiment of the present disclosure has been explained. In the present embodiment, the display device 300 is the rear-barrier 3D display device in which the parallax barrier 320 is disposed on the back side of the LCD 130, however, the embodiment of the present disclosure is not limited to the specific structure of the light separation portion. For example, the display device according to the embodiment of the present disclosure may be the front-barrier 3D display device in which the parallax barrier is disposed on the front side of the LCD. Additionally, the light separation portion is not limited to the parallax barrier but the liquid crystal lens explained in the above second embodiment or the liquid lens can be used. Moreover, when the display device displays multi-viewpoint images, the number of viewpoints is not limited to four, and for example, a given number of viewpoints such as five viewpoints or six viewpoints can be applied.

### 4. Other Embodiments

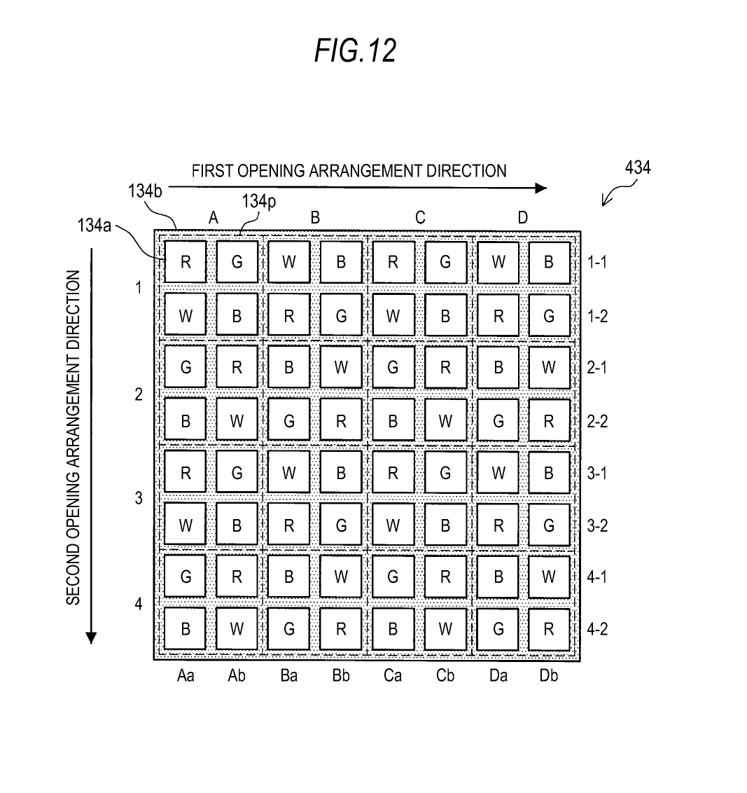

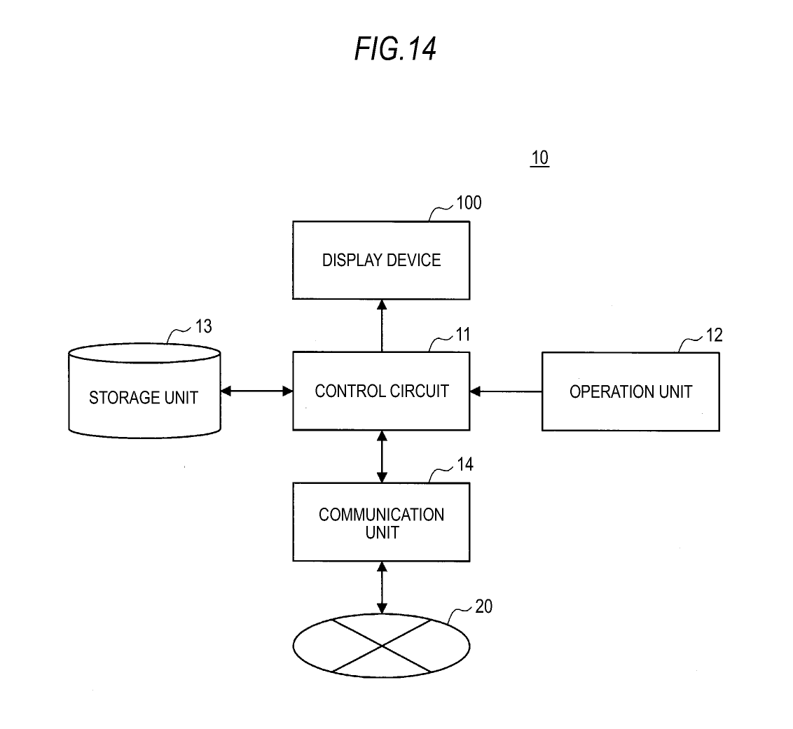

Subsequently, other embodiments of the present disclosure will be explained with reference to FIG. 12 and FIG. 14.

### (Color Arrangement of Pixel Openings)

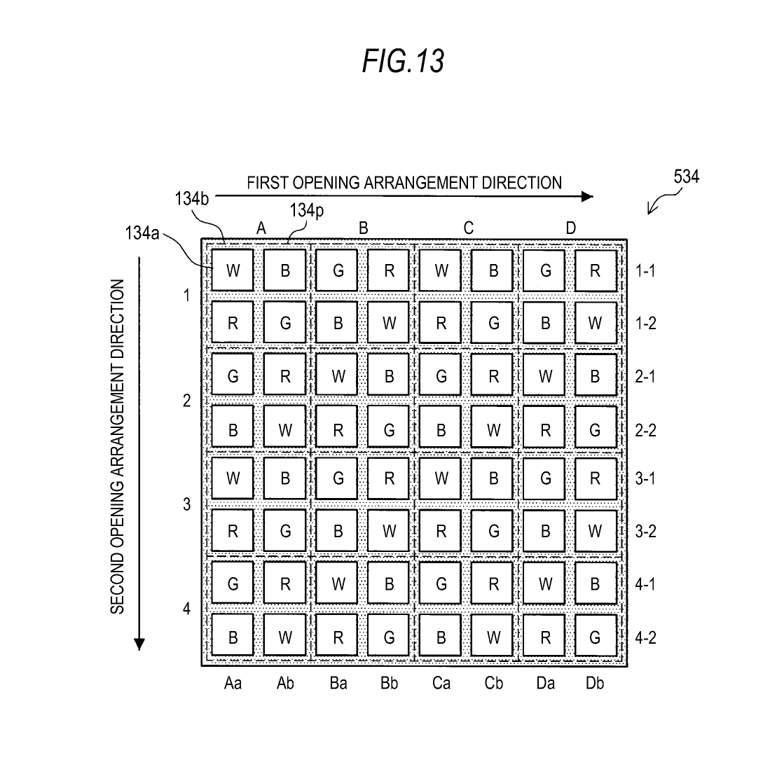

FIG. 12 and FIG. 13 are views showing other examples of color arrangement of pixel openings according to embodiments of the present disclosure. Color filters 434 shown in FIG. 12 and color filters 534 shown in FIG. 15 are the same as the color filters 134 explained in the first embodiment in the following points.

The pixel openings 134a are arranged in the horizontal direction (first opening arrangement direction) and the horizontal direction (second opening arrangement direction).

The ratio of colors displayed by the pixel openings 134a arranged in the same line in respective horizontal and vertical directions is equal to the ratio of colors included in the pixel 134p.

However, in color filters 434 and 534, specific color arrangements of pixel openings 134a are different from the color arrangement of the color filters 134. This means that there are many variations for satisfying the above conditions in the color arrangement of the pixel openings 134a. Even in the structure in which the color arrangement of the block including the pixel openings 134a of four lines in the vertical and horizontal directions is repeated as a pattern such as in the color filters 134, 434 and 534 explained as the above, other many variations exist. When including color arrangements in which the range of the pattern to be repeated is different (for example, a block including the pixel openings 134a of eight lines in the vertical and horizontal directions and so on), the color arrangement of the pixel openings 134a has almost infinite variations.

That is, the color arrangement of the pixel openings according to the embodiments of the present disclosure is not limited to the ones exemplified in the specification and various color arrangements are included as long as “the ratio of colors displayed by the pixel openings arranged in the same line in the first opening direction and in the second opening direction is equal to the ratio of colors included in the pixel” in the color arrangement.

### (Electronic Apparatus)

FIG. 14 is a schematic block diagram showing a configuration of an electronic apparatus according to an embodiment of the present disclosure. The display devices explained in respective embodiments can be incorporated in the electronic apparatus. The electronic apparatus is included in the embodiment of the present disclosure.

Referring to FIG. 14, an electronic apparatus 10 includes the display device 100, a control circuit 11, an operation unit 12, a storage unit 13 and a communication unit 14. The electronic apparatus 10 is any of apparatuses including the display device 100 as the display portion, such as a television, a cellular phone (smart phone), a digital camera, a personal computer and so on.

The control circuit 11 includes, for example, CPU (central processing unit), a RAM (random access memory), a ROM (read only memory) and so on, controlling respective units of the electronic apparatus 10. The display device 100 is also controlled by the control circuit 11.

The operation unit 12 includes, for example, a touch pad, buttons, a keyboard, a mouse or the like, receiving operation input with respect to the electronic apparatus 10 by a user. The control circuit 11 controls the electronic apparatus 10 in accordance with the operation input acquired by the operation unit 12.

The storage unit 13 includes, for example, a semiconductor memory, a magnetic disc, an optical disc or the like, storing various data necessary for allowing the electronic apparatus 10 to function. The control circuit 11 may be operated by reading a program stored in the storage unit 13 and executing the program.

The communication unit 14 is provided as an additional unit. The communication unit 14 is a communication interface connected to a wired or wireless network 20, including, for example, a modem, a port, an antenna or the like. The control circuit 11 receives data from the network 20 as well as transmits data to the network 20 through the communication unit 14.

In the above example, the electronic apparatus 10 including the display device 100 according to the first embodiment of the present disclosure has been explained, however, it is also possible to realize electronic apparatuses including the display devices 200 and 300 according to the second and third embodiments as well as display devices according to other embodiments in the same manner.

(Colors included in Pixel)

In the above embodiments, the example in which each pixel of the LCD includes four colors of red (R), green (G), blue (B) and white (W) has been explained, however, the embodiments of the present disclosure are not limited to the example. For example, each pixel may include three colors of red (R), green (G) and blue (B), and may also include five or more colors. Additionally, when the pixel includes four colors, colors included in the pixel can be arbitrarily set, such that yellow (Y) is used instead of white (W).

Additionally, it is not always necessary that colors included in the pixel are not different from one another. For example, when the pixel includes four colors, four colors may include repeated colors, for example, red (R), green (G), green (G) and blue (B). In this case, the ratio of colors included in the pixel is R:G:B is 1:2:1, therefore, the ratio of colors displayed by the pixel openings arranged in the same line in the first and second opening arrangement directions will be R:G:B=1:2:1.

### (Types of Display Portion)

In the above embodiments, the example in which the display portion is the LCD has been explained, however, the embodiments of the present disclosure are not limited to the example. For example, the display portion may be a self-luminous display such as an organic EL (electro luminescence) display. In this case, the pixel openings can be areas displaying colors included in the pixel as electric fields for allowing self-luminous devices of respective colors to emit light. For example, in the case of the organic EL display, the pixel openings can be openings formed by an insulating film provided between a lower electrode and a light emitting layer.

### 5. Supplement

The preferred embodiments of the present disclosure have been explained in detail with reference to the attached drawings as the above, however, the technical scope of the present disclosure is not limited to these embodiments. It is obvious that various alternations and modifications may occur to those skilled in the technical field of the present disclosure within the scope of technical ideas described in the appended claims, which naturally belong to the technical ideas of the present disclosure.

The following configurations also belong to the technical scope of the present disclosure.

(1) A display device including

a display portion in which pixel openings displaying colors included in a pixel are arranged in a first direction and a second direction which is different from the first direction, and the ratio of colors displayed by the pixel openings arranged in the same line is equal to the ratio of colors included in the pixel, and

a light separation portion dividing an image displayed on the display portion into plural viewpoint images by spatially separating light, and the dividing direction is switched between the first direction and the second direction.

(2) The display device described in the above (1),

in which the number of colors included in the pixel is n-colors (n≧3), and

the colors displayed by the pixel openings are arranged by repeating a pattern including one of each of the n-colors at least in the first direction or in the second direction.

(3) The display device described in the above (2),

in which the number of colors included in the pixel is four.

(4) The display device described in the above (2) or (3),

in which colors included in the pixel are different from one another.

(5) The display device described in any of the above (1) to (4),

in which the light separation portion divides the image displayed on the display portion into plural viewpoint images in units of one line of pixel openings arranged in the first direction or in the second direction.

(6) The display device described in any of the above (1) to (4),

in which the light separation portion divides the image displayed on the display portion into plural viewpoint images in units of plural lines of pixel openings arranged in the first direction or in the second direction.

(7) The display device described in any of the above (1) to (6),

in which the light separation portion is a parallax barrier.

(8) The display device described in any of the above (1) to (6),

in which the light separation portion is a liquid crystal lens.

(9) The display device described in any of the above (1) to (8),

in which the pixel openings are areas through which light from a backlight included in the display portion is transmitted.

(10) The display device described in any of the above (1) to (8),

in which the pixel openings are areas in which electric fields for allowing self-luminous devices included in the display portion to emit light are generated.

(11) An electric apparatus including

a display device in which pixel openings displaying colors included in a pixel are arranged in a first direction and a second direction which is different from the first direction, and the ratio of colors displayed by the pixel openings arranged in the same line is equal to the ratio of colors included in the pixel, and

a light separation portion dividing an image displayed on the display portion into plural viewpoint images by spatially separating light, and the dividing direction is switched between the first direction and the second direction.

The present disclosure contains subject matter related to that disclosed in Japanese Priority Patent Application JP 2012-055755 filed in the Japan Patent Office on Mar. 13, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display portion in which pixel openings displaying colors included in a pixel are arranged in a first direction and a second direction which is different from the first direction, and the ratio of colors displayed by the pixel openings arranged in the same line is equal to the ratio of colors included in the pixel; and
a light separation portion dividing an image displayed on the display portion into plural viewpoint images by spatially separating light, and the dividing direction is switched between the first direction and the second direction.

2. The display device described according to claim 1,
wherein the number of colors included in the pixel is n-colors (n≧3), and
the colors displayed by the pixel openings are arranged by repeating a pattern including one of each of the n-colors at least in the first direction or in the second direction.

3. The display device described according to claim 2,
wherein the number of colors included in the pixel is four.

4. The display device described according to claim 2,
wherein colors included in the pixel are different from one another.

5. The display device described according to claim 1,
wherein the light separation portion divides the image displayed on the display portion into plural viewpoint images in units of one line of pixel openings arranged in the first direction or in the second direction.

6. The display device described according to claim 1,
wherein the light separation portion divides the image displayed on the display portion into plural viewpoint images in units of plural lines of pixel openings arranged in the first direction or in the second direction.

7. The display device described according to claim 1,
wherein the light separation portion is a parallax barrier.

8. The display device described according to claim 1,
in which the light separation portion is a liquid crystal lens.

9. The display device described according to claim 1,
wherein the pixel openings are areas through which light of colors included in the pixel is transmitted.

10. The display device described according to claim 1,
in which the pixel openings are areas in which electric fields for allowing self-luminous devices of colors included in the pixel to emit light are generated.

11. An electric apparatus comprising:
a display device in which pixel openings displaying colors included in a pixel are arranged in a first direction and a second direction which is different from the first direction, and the ratio of colors displayed by the pixel openings arranged in the same line is equal to the ratio of colors included in the pixel, and
a light separation portion dividing an image displayed on the display portion into plural viewpoint images by spatially separating light, and the dividing direction is switched between the first direction and the second direction.
